(19) United States
(12) Patent Application Publication
(10) Pub. No.: US 2002/0059289 A1
(43) Pub. Date: May 16, 2002

(54) Methods and systems for generating and searching a cross-linked keyphrase ontology database

(76) Inventors: Brant Gary Wenegrat, Palo Alto, CA (US); David B. DeGraaff, Lafayette, CA (US); Jeffrey E. Davitz, San Ramon, CA (US); Mariya B. Orshansky, Oakland, CA (US); Jiye Yu, Walnut Creek, CA (US)

Correspondence Address: WHITE & CASE LLP, PATENT DEPARTMENT, 1155 AVENUE OF THE AMERICAS, NEW YORK, NY, 10036, US

(21) Appl. No.: 09/900,306

(22) Filed: Jul. 6, 2001

Related U.S. Application Data
(60) Provisional application No. 60/216,846, filed on Jul. 7, 2000.

(51) Int. Cl. G06F 7/00

(52) U.S. Cl. 707/102

(57) ABSTRACT

The methods and systems of the invention involve the generation and use of a cross-linked keyphrase ontology database. The database is generated by defining at least one keyphrase, representing the keyphrase by a keyphrase node in an ontology, cross-linking the keyphrase node to a second keyphrase node, and then repeating the preceding steps for each keyphrase defined. A retrievable object can be indexed in a cross-linked keyphrase ontology database by representing the retrievable object by an object node in an ontology and then cross-linking the object node to a keyphrase node, where the keyphrase node represents a keyphrase in a second ontology and the keyphrase is related to the retrievable object. The cross-linked keyphrase ontology database can be searched by parsing a natural language statement into a structured representation and searching the cross-linked keyphrase ontology database. The cross-linked ontology database can be used for disambiguating syntactically ambiguous natural language statements.

This application claims priority from U.S. Provisional Patent Application Serial No. 60/216846 filed Jul. 7, 2000.

### BACKGROUND OF THE INVENTION

With the explosion of information over the last twenty years, it has become very difficult for people to find the information they are looking for. The World Wide Web contains well over one billion web pages, and even corporate databases like large product catalogs, or domain-specific databases like Medline, often have many millions of documents, making the search for a particular product or piece of information extremely difficult. If the searcher does not know the exact name, address, or identification number of the item he is trying to find, he must often dig through thousands of search results to find relevant information. What is needed is a method for finding retrievable objects, such as documents, that is easy and provides excellent recall and precision.

Keyword searches over document databases are the most common way searchers find documents. A keyword index gives the user the ability to enter words. If the words are present in an indexed document, then the document is returned in the search results. Keyword searches are prone to both precision or recall errors. Precision errors occur when a search returns objects not sought by the user. Recall errors occur when a search fails to return all the existing objects sought by the user. Precision errors result from polysemy and from lack of syntactical context. For example, if the keywords are “computer” and “chair,” returned elements may well concern furniture, computers, and the Chair of the Computer department. Recall errors result from synonymy. “Chair” for instance, might be used to mean “head of the department,” but a relevant document might be indexed under the keyword “chairperson,” resulting in failure to match that document.

Some keyword search systems use a thesaurus to broaden out search terms and thereby reduce recall errors. Since synonym sets in English and other languages overlap considerably, however, the use of a thesaurus leads to worse precision. “Blues” for instance, is a synonym for “depression” as well as a type of music. Thus a user searching for items related to music may also be returned items related to mood. Boolean syntax, such as “and” and “or” searches may also be used with common keyword systems to improve precision and recall, but this is beyond the abilities of all but the most sophisticated users.

Keyword methods have been extended to keyphrase searching by allowing multiple words enclosed by quotation marks to be used as alphanumeric strings. This type of keyphrase search proceeds identically to a keyword search, except that spaces are enclosed within the string being sought. Additionally, this type of keyphrase search can improve precision, but it exacerbates recall errors, since an exact phrase match is required.

Keyword methods have also been extended to allow natural language input from users. Natural language is language as it is commonly written or spoken, e.g., “I want an Italian leather handbag with a matching wallet.” Some natural language systems allow this type of input, but they generate a keyword search from the substantive words in the input, such as “Italian and leather and handbag and matching and wallet.” While this makes the search input easy for the user, since natural language is the most natural way to state a request, by transforming the search into a boolean keyword search it discards much of the syntactic information supplied by the natural language, thus reducing the relevance of the search results.

Fujisawa et al. discloses the use of a semantic network to index and retrieve documents. (Fujisawa, et al., in U.S. Pat. No. 5,555,408). The methods disclosed by Fujisawa et al., however, require extensive knowledge engineering effort in deployment.

Another known interface type allows natural language queries of items which are annotated to describe their content (Katz et al., U.S. Pat. Nos. 5,309,359 and 5,404,295). A natural language understanding system is used to map natural language queries onto the annotations, and the documents that have matching annotations are returned to the user. The annotation process may be laborious and the quality of results is highly dependent on the functioning of the natural language understanding system. This invention addresses the problems of keyword searching, semantic networks, and annotation searches by allowing high precision, high recall natural language searching with minimal knowledge engineering. The objects are indexed in a database of cross-linked keyphrases, which also allows disambiguation of the natural language.

### SUMMARY OF THE INVENTION

The methods and systems of the invention involve the generation and use of a cross-linked keyphrase ontology database. A cross-linked keyphrase ontology database is created by: (a) defining at least one keyphrase; (b) representing the keyphrase by a keyphrase node in an ontology; (c) cross-linking the keyphrase node to at least one second keyphrase node, where the second keyphrase node represents a second keyphrase in a second ontology; and (d) repeating steps (b)-(c) for each keyphrase defined in step (a). The keyphrase in step (a) may be generated by parsing a text and can be selected from a group consisting of nouns, adjectives, verbs and adverbs. In one embodiment, the keyphrase in step (a) and the second keyphrase have at least one word in common. The text parsed may be in English or in any other written or spoken language.

The methods and systems of the invention also allow for indexing a retrievable object in a cross-linked keyphrase ontology database. Indexing comprises the steps of: (a) representing the retrievable object by an object node in an ontology; and (b) cross-linking the object node to a keyphrase node, where the keyphrase node represents a keyphrase in a second ontology and the keyphrase is related to the retrievable object. In one embodiment, the keyphrase is determined by parsing a text associated with the retrievable object. The retrievable object may be a document, a web page, a pointer or an executable computer program.

The methods and systems of the invention also permit searching of a cross-linked keyphrase ontology database. Searching comprises the steps of: (a) parsing a natural language statement into a structured representation, where the structured representation comprises at least one keyphrase; (b) searching the cross-linked keyphrase ontology database for at least one object node, where the object node is cross-linked to a keyphrase node representing a second keyphrase and where the second keyphrase matches the keyphrase parsed in step (a); and (c) defining a search result as a retrievable object, wherein the retrievable object is represented by the object node. The search result can be displayed to a user in a list. The retrievable object may be an executable computer program. The natural language statement may be a query.

In one embodiment, the keyphrase in step (a) and the second keyphrase are identical. In another embodiment, the keyphrase in step (a) and the second keyphrase are synonyms. In yet another embodiment, the keyphrase in step (a) and the second keyphrase are metonyms.

Searching may be done in a natural language such as English or in any other written or spoken language.

The methods and systems of the invention also permit disambiguating a syntactically ambiguous natural language statement. Disambiguation comprises the steps of: (a) parsing the syntactically ambiguous natural language statement into at least two structured representations, where the first structured representation comprises at least one first keyphrase and the second structured representation comprises at least one second keyphrase; (b) searching a cross-linked keyphrase ontology database for a keyphrase node representing a third keyphrase, where the third keyphrase matches the first keyphrase or the second keyphrase; (c) if the first keyphrase matches the third keyphrase and the second keyphrase does not match the third keyphrase, designating the first structured representation as a first disambiguated statement interpretation; (d) if the second keyphrase matches the third keyphrase and the first keyphrase does not match the third keyphrase, designating the second disambiguated structured representation as a second statement interpretation; and (e) if the first keyphrase matches the third keyphrase and the second keyphrase matches the third keyphrase, or the first keyphrase does not match the third keyphrase and the second keyphrase does not match the third keyphrase, determining that the syntactically ambiguous natural language statement cannot be disambiguated.

The syntactically ambiguous natural language statement may be a query. In one embodiment, the third keyphrase is identical to the first keyphrase or the second keyphrase. In another embodiment, the third keyphrase is a synonym of the first keyphrase or the second keyphrase, while in another embodiment the third keyphrase is a metonym of either the first keyphrase or the second keyphrase. Disambiguation may be done on a syntactically ambiguous natural language statement in the English language or in any other spoken or written language.

### BRIEF DESCRIPTION OF THE FIGURES

FIG. 1 is a diagram illustrating the notations used.

FIG. 2 is a diagram illustrating a cross-linked keyphrase ontology database.

FIG. 3 is a diagram showing a cross-linking scheme for a three-word keyphrase.

FIG. 4 is a diagram showing an alternative cross-linking scheme for a three-word keyphrase.

FIG. 5 is a diagram illustrating a cross-linked keyphrase ontology database having deeper ontologies than in FIG. 2.

FIG. 6 is a diagram showing a verb ontology with cross-linking of keyphrase nodes.

FIG. 7 is a diagram showing an alternate verb keyphrase cross-linking scheme.

FIG. 8 is a diagram showing a section of a cross-linked keyphrase ontology database for a shoe manufacturer.

FIG. 9a is a diagram illustrating the indexing of retrievable objects from a table.

FIG. 9b is a diagram illustrating the indexing of retrievable objects from a text.

FIG. 10 is a structured representation of a sample query.

FIG. 11 is a diagram showing the disambiguation process.

FIG. 12 is a structured representation of a sample keyphrase.

FIG. 13 is an alternate structured representation of the sample keyphrase in FIG. 12.

FIG. 14 is a structured representation of a sample keyphrase.

FIG. 15 is an alternate structured representation of the keyphrase in FIG. 14.

FIG. 16 is a diagram showing the system of the invention.

FIG. 17 is a structured representation of a sample query.

FIG. 18 is a truncated structured representation of the sample query of FIG. 17.

FIG. 19 is a second truncated structured representation of the sample query of FIG. 17.

### DETAILED DESCRIPTION OF THE INVENTION

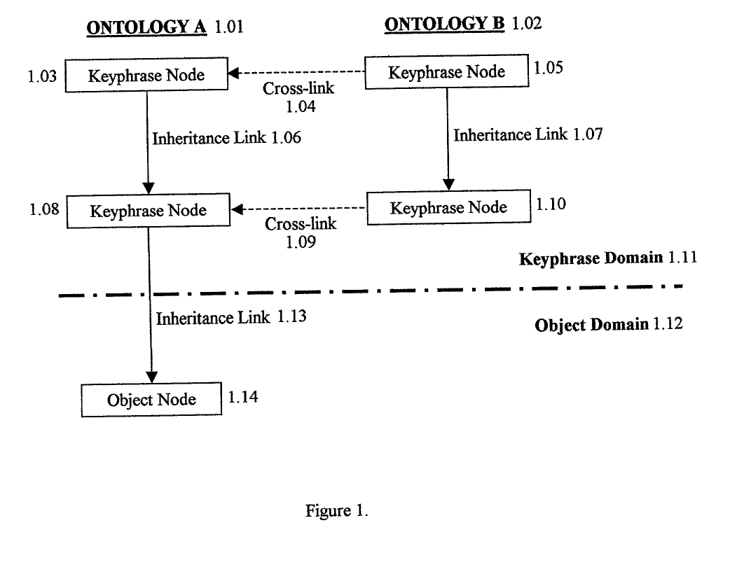

FIG. 1 illustrates the terms used in the figures. Two ontologies 1.01 and 1.02 are shown, where an ontology is a set of nodes linked by inheritance links 1.06, 1.07 and 1.13. Inheritance links 1.06, 1.07 and 1.13 are shown on this and subsequent figures as solid lined arrows, which originate at a parent node and terminate at a child node. The parent of a given node 1.03 is a node from which an inheritance link 1.06 that terminates on that given node 1.08 originates. The child of a given node 1.08 is a node on which an inheritance link 1.06 that originates from that given node 1.03 terminates. Like family trees, all of a node's parents, and its parent's parents, and so on, recursively, form the node's ancestors, and all of a node's children, and its children's children, and so on, recursively, form the node's descendants. Inheritance means that if a node is the recipient of a cross-link, then any descendant from that node is also a recipient of the cross-link. In FIG. 1, for example, keyphrase node 1.08 inherits a cross-link to keyphrase node 1.05, and the object node 1.14 inherits cross-links to both keyphrase node 1.05 and keyphrase node 1.10.

A node is in the same ontology as a second node if either of the nodes is an ancestor of the other node, or if the nodes share a common ancestor node. For example, in FIG. 1, node 1.03 and node 1.14 are in the same ontology 1.01 because node 1.03 is an ancestor of node 1.14 through inheritance links 1.13 and 1.06. Node 1.08 and node 1.14 are in the same ontology 1.01 because (i) they share the same ancestor node 1.03 and (ii) node 1.08 is an ancestor of node 1.14 through inheritance link 1.13. Node 1.05 is in a different ontology from node 1.14 since node 1.05 is not an ancestor of node 1.14, node 1.14 is not an ancestor of node 1.05, and there are no nodes which are ancestors of both node 1.14 and 1.05.

Cross-links 1.04 and 1.09 are shown in this and subsequent figures as broken-line arrows, which originate at the node that supplies the keyphrase (e.g., keyphrase node 1.05), and terminate at the node which receives the keyphrase (e.g., keyphrase node 1.03). Cross-link terminations (or cross-link recipient status) are inherited in each ontology. As used herein, the term node may refer to keyphrase nodes or object nodes.

Cross-linked Keyphrase Ontology Database

The methods of the invention involve the generation and use of a cross-linked keyphrase ontology database. A cross-linked keyphrase ontology database is created by: (a) defining at least one keyphrase; (b) representing the keyphrase by a keyphrase node in an ontology; (c) cross-linking the keyphrase node to at least one second keyphrase node, wherein the second keyphrase node represents a second keyphrase in a second ontology; and (d) repeating steps (b)-(c) for each keyphrase defined in step (a). The keyphrase in step (a) may be generated by parsing a text and can be selected from a group consisting of nouns, adjectives, verbs and adverbs. In one embodiment, the keyphrase in step (a) and the second keyphrase have at least one word in common. The text parsed may be in English or in any other written or spoken language.

As shown in FIG. 1, a cross-linked keyphrase ontology database is a database in which objects are represented as object nodes 1.14 attached to cross-linked ontologies 1.01 and 1.02. Ontologies of keyphrases 1.01 and 1.02 are stored in the keyphrase domain 1.11 which contains keyphrase nodes 1.03, 1.05, 1.08 and 1.10, while particular objects that might be retrieved are stored in the object domain 1.12 which contains object nodes 1.14. Keyphrase nodes 1.03, 1.05, 1.08 and 1.10 are nodes that, together with their inheritance links 1.06, 1.07 and 1.13 and cross-links 1.04 and 1.09, represent keyphrases. Object nodes 1.14 are nodes that represent at least one retrievable object, such as pages, web pages, files, documents, product or business names, descriptions, information, or commands. A command can be an executable computer program. For example, a command might be a script that launches a computer program. In many applications, the command is executed when the object node is returned in the result set of a query. For example, the query by a user “what is my checking account balance,” might result in an object node that executes a sequence of commands that first ascertains the user's checking account number, accesses a database to determine the account balance, and then displays the account balance to the user.

As seen in FIG. 1, the object nodes 1.14 are part of at least one ontology (e.g., Ontology A 1.01 in FIG. 1). Object nodes 1.14 may contain the retrievable object directly, or they may contain a pointer to the retrievable object which allows the object to be recovered if it is returned as part of a search result. The pointer may be a file path, or if the retrievable object is a web page, the pointer may be Uniform Resource Locator (URL).

Keyphrases stored in the keyphrase domain 1.11 are arranged in ontologies 1.01 and 1.02. The ontologies 1.01 and 1.02 are used to define the inheritance of cross-links 1.04 and 1.09, and taken together, inheritance links 1.06, 1.07 and 1.13 and cross-links 1.04 and 1.09 form keyphrases. A keyphrase is an ordered series of one or more words, which may contain nouns, verbs, adjectives and adverbs. Two-word keyphrases are stored in the keyphrase domain as cross-linked keyphrase nodes (e.g. 1.03 and 1.05), or as ontology intersections. An ontology intersection is a node connected by inheritance links to more than one ontology. As shown in FIG. 1, cross-links 1.04 and 1.09 are directional, with origins (keyphrase nodes) 1.05 and 1.10 (arrow tail) and recipients (keyphrase nodes) 1.03, 1.08, and 1.14 (arrow head). The origin 1.05 and 1.10 of a cross-link 1.04 and 1.09 is a keyphrase node that represents a keyphrase. The recipient 1.03, 1.08 and 1.14 of a cross-link 1.04 and 1.09 is a keyphrase node that represents a keyphrase and/or a retrievable object or may have descendants which are object nodes representing retrievable objects. If the recipient node represents a keyphrase and has no descendants that are object nodes, the keyphrase which the origin of the cross-link represents will be part of the keyphrase the recipient represents. If the node that receives a cross-link 1.03, 1.08 and 1.14 represents a retrievable object or has descendants which are object nodes, as in Ontology A 1.01, the keyphrase which the origin nodes 1.05 and 1.10 represent may be a keyphrase by which the retrievable object or the set of object nodes descendant from the recipient is to be matched, rather than just a sub-phrase or keyphrase represented by the recipient node 1.03, 1.08 and 1.14 keyphrase.

This invention is illustrated in the specific examples which follow. These sections set forth below the understanding of the invention, but are not intended to, and should not be construed to, limit in any way the invention as set forth in the claims which follow thereafter.

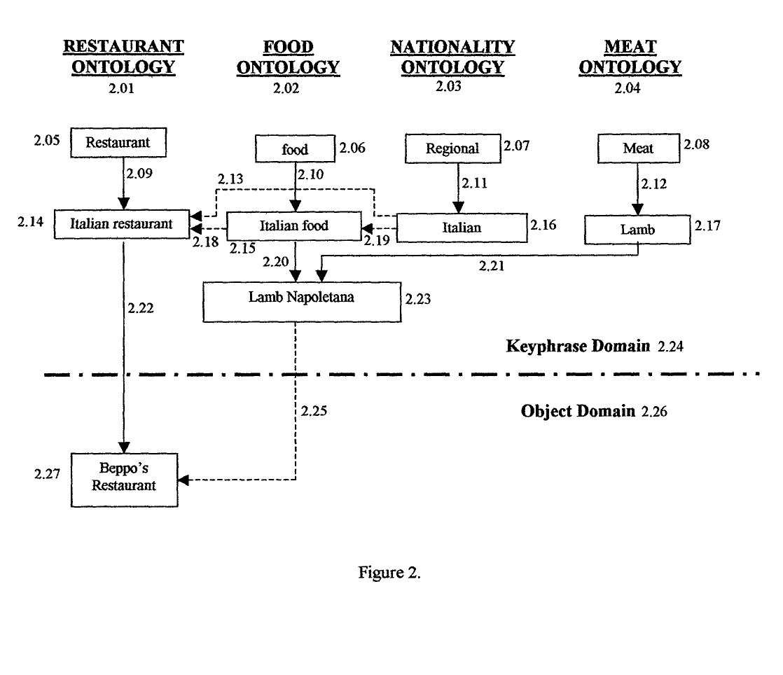

These points are illustrated by FIG. 2, which shows a keyphrase domain 2.24 and an object domain 2.26 for a database used to index restaurants. The keyphrase domain shown in FIG. 2 has four ontologies, one for restaurants (which are retrievable objects) 2.01, one for food types 2.02, one for nationalities 2.03 and one for meat 2.04. As shown in FIG. 2, the restaurant ontology 2.01 contains two keyphrase nodes 2.05 and 2.14, representing the keyphrases “restaurant” and “Italian restaurant”, respectively, from which an object node representing a retrievable object descends. The food ontology 2.02 shown in FIG. 2 has three keyphrase nodes 2.06, 2.15 and 2.23, representing the keyphrases “food,” “Italian food,” and “lamb Napoletana”, respectively. The nationality ontology 2.03 shown in FIG. 2 contains two keyphrase nodes 2.07 and 2.16, representing the keyphrases “regional” and “Italian”, respectively. The meat ontology 2.04 contains three keyphrase nodes representing the keyphrases “meat”, “lamb” and “lamb Napoletana,” respectively. The object domain 2.26 as shown in FIG. 2 includes just one keyphrase node 2.27 representing a retrievable object, “Beppo's Restaurant”. The keyphrase node 2.14 representing the keyphrase “Italian restaurant” is the recipient of a cross-link 2.13 from a keyphrase node 2.16 representing the keyphrase “Italian”, which is part of keyphrase “Italian restaurant” (keyphrase node 2.14), and also is the recipient of a cross-link 2.18 from a keyphrase node 2.15 representing the keyphrase “Italian food”, which is a keyphrase by which the object node 2.27 descendant from the keyphrase “Italian restaurant” (keyphrase node 2.14) can be matched. The keyphrase node 2.15 representing the keyphrase “Italian food” 2.15, by contrast, is only the recipient of a cross-link 2.19 from a keyphrase node 2.16 representing the keyphrase “Italian,” which is a part of the keyphrase, it represents “Italian food” (keyphrase node 2.15).

Cross-links between keyphrase nodes in a cross-linked keyphrase ontology database can be used to represent syntactic relations inherent in keyphrases. For example, the keyphrase “Italian food” (keyphrase node 2.15) is represented in the cross-linked keyphrase ontology database shown in FIG. 2 as a keyphrase node 2.15 cross-linked 2.19 to another keyphrase node 2.16. It has the parent keyphrase node 2.06 representing “food” and is modified by the keyphrase “Italian” (keyphrase node 2.16), which exists in a different ontology 2.07. The cross-linked keyphrase node 2.15 representing the keyphrase “Italian food” corresponds to a type of keyphrase food (keyphrase node 2.06) modified by the keyphrase “Italian” (keyphrase node 2.16). The keyphrase “lamb Napoletana” (keyphrase node 2.23) is stored in the database shown in FIG. 2 as an ontology intersection. It has a parent keyphrase “Italian food” (keyphrase node 2.15) and a parent keyphrase “lamb” (keyphrase node 2.17) each from a different ontology 2.02 and 2.04. Three or more word keyphrases can be represented in the keyphrase domain 2.24 by cross-links or intersections with nodes representing keyphrases with fewer words.

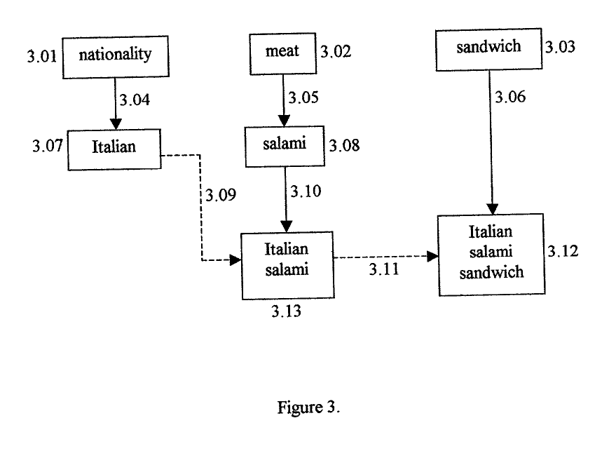

FIG. 3 shows a possible keyphrase domain of a cross-linked keyphrase ontology database, which contains three ontologies, for nationality, meat, and for sandwiches. The nationality ontology contains just two keyphrase nodes 3.01 and 3.07, the meat ontology contains three keyphrase nodes 3.02, 3.08 and 3.13, and the sandwich ontology contains just two keyphrase nodes 3.03 and 3.12. Keyphrase nodes in each ontology are joined by inheritance links 3.04, 3.05, 3.06 and 3.10. FIG. 3 shows the representation of the keyphrase “Italian salami sandwich” (keyphrase node 3.12). “Italian” (keyphrase node 3.07) modifies “salami” (keyphrase node 3.08), not “sandwich” (keyphrase node 3.03), so the two word keyphrase “Italian salami” (keyphrase node 3.13) is represented by an inheritance link 3.10 to the keyphrase node 3.08 representing the keyphrase “salami” and cross-linked 3.09 to the keyphrase node 3.07 representing “Italian.” The keyphrase “Italian salami sandwich” (keyphrase node 3.12) can then be represented by an inheritance link 3.06 to the keyphrase node 3.03 representing the keyphrase “sandwich” 3.03 which is cross-linked 3.11 to a keyphrase node 3.13 representing the keyphrase “Italian salami.” Three or more word keyphrases can also be represented in the keyphrase domain by means of multiple cross-links, possibly in combination with ontology intersections.

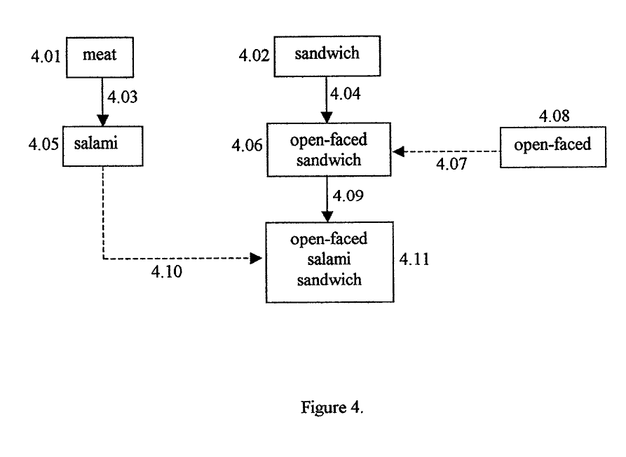

FIG. 4 shows a representation in a cross-linked keyphrase ontology database of the example keyphrase “open-faced salami sandwich” (keyphrase node 4.11). The keyphrase “open-faced” (keyphrase node 4.08) modifies “sandwich” (keyphrase node 4.02), not “salami” (keyphrase node 4.05), so the keyphrase “open-faced salami sandwich” (keyphrase node 4.11) can be represented by an inheritance link 4.09 to the keyphrase node 4.06 representing the keyphrase “open-faced sandwich” which is cross-linked 4.10 to a keyphrase node 4.05 representing the keyphrase “salami.” The keyphrase node 4.06 representing the keyphrase“open-faced sandwich” can be represented by an inheritance link 4.04 to the keyphrase node 4.02 representing the keyphrase “sandwich,” which cross-linked 4.07 to the keyphrase node 4.08 representing the keyphrase “open-faced.” As in the case of two word keyphrases, representations of multi-word keyphrases follow syntactic linkages in the phrases themselves.

Keyphrase nodes in a keyphrase domain can be described by the keyphrases they represent or by other keyphrases. The following rules determine the keyphrases with which a keyphrase node can be described. Aside from the keyphrase which it represents, the set of keyphrases which can be used to describe a keyphrase node include:

(I) the names of its ancestors in the keyphrase domain ontology(ies) to which it is attached by inheritance links; and

(II) keyphrases formed by concatenating a first and second keyphrase, in which the second element is determined by rule I and the first element is either II(a) the name of a keyphrase node in another ontology, from which it receives a cross-link, either directly or by inheritance from its ancestors, or II(b) the name of a keyphrase node ancestral to a keyphrase node in another ontology from which it receives a cross-link, directly or by inheritance.

In FIG. 2, for example, the keyphrase node 2.23 which represents “lamb Napoletana” can be described, by rule I, by the keyphrase “lamb” 2.17, and by rule II(a) by the keyphrase “Italian lamb,” which is formed by concatenating “Italian” 2.16 with “lamb” 2.17. The keyphrase node 2.23 which represents “lamb Napoletana” can also be described, by rule II(b), by the keyphrase “regional lamb,” which is formed by concatenating “regional” 2.07 with “lamb” 2.17.

Keyphrase nodes in a keyphrase domain can be described by the keyphrases they represent or by other keyphrases. The following rules determine the keyphrases with which a keyphrase node can be described. Aside from the keyphrase which it represents, the set of keyphrases which can be used to describe a keyphrase node include:

(I) the names of its ancestors in the keyphrase domain ontology(ies) to which it is attached by inheritance links,

(II) keyphrases formed by concatenating a first and second keyphrase, in which the second element is determined by rule I and the first element is either II(a) the name of a keyphrase node in another ontology, from which it receives a cross-link, either directly or by inheritance from its ancestors, or II(b) the name of a keyphrase node ancestral to a keyphrase node in another ontology from which it receives a cross-link, directly or by inheritance.

In FIG. 2, for example, the keyphrase node 2.23 which represents “lamb Napoletana” can be described, by rule I, by the keyphrase “lamb” 2.17, and by rule II(a) by the keyphrase “Italian lamb,” which is formed by concatenating “Italian” 2.16 with “lamb” 2.17. The keyphrase node 2.23 which represents “lamb Napoletana” can also be described, by rule II(b), by the keyphrase “regional lamb,” which is formed by concatenating “regional” 2.07 with “lamb” 2.17.

The following rules determine the set of keyphrases linked to an object node (and hence, to the object it represents) in the object domain of the cross-linked keyphrase ontology database. The set of keyphrases linked to an object node (and hence to the object it represents) in the object domain include:

(i) the names of its ancestors in the keyphrase domain ontology(ies) to which it is attached by inheritance links, and

(ii) the names of the keyphrase nodes in other ontologies from which it receives cross-links, either directly or by inheritance from its ancestors, and

(iii) the additional keyphrases, by rules (i) and (ii) above, by which keyphrase nodes from which it receives cross-links, directly or by inheritance, can be described.

In FIG. 2, for example, by rule (i) the object “Beppo's restaurant,” which is represented by an object node 2.27, is linked to the keyphrase “restaurant” (keyphrase node 2.05); by rule (ii) the object “Beppo's restaurant,” which is represented by an object node 2.27, is linked to the keyphrase “Lamb Napoletana” (keyphrase node 2.23); and, by rule (iii) the object “Beppo's restaurant,” which is represented by an object node 2.27, is linked to the keyphrase “Italian lamb.”

For matching an object node in a cross-linked ontology database with an object node in a structural representation for searching (see below), an object node linked with a keyphrase node representing a keyphrase defined by rule 3 is considered cross-linked to a keyphrase node representing that keyphrase.

Once a keyphrase descriptive of a set of retrievable objects in the object domain has been represented in the keyphrase domain, then it can also receive cross-links from keyphrase nodes in other ontologies representing keyphrases with which the set of objects may be associated, and which might therefore be spoken or written by users looking for objects in the relevant retrievable set. In FIG. 2, for example, the keyphrase node 2.14 representing the keyphrase “Italian restaurant” receives a cross-link 2.18 from the keyphrase node 2.15 in the food ontology 2.02 representing the keyphrase “Italian food.”Note that the keyphrase “Italian food” has no specified syntactic or predicate relation to the keyphrase “Italian restaurant” (keyphrase node 2.14), but that the cross-link 2.18 serves only to link a keyphrase to descendants of the keyphrase node 2.14 representing keyphrase “Italian restaurant”.

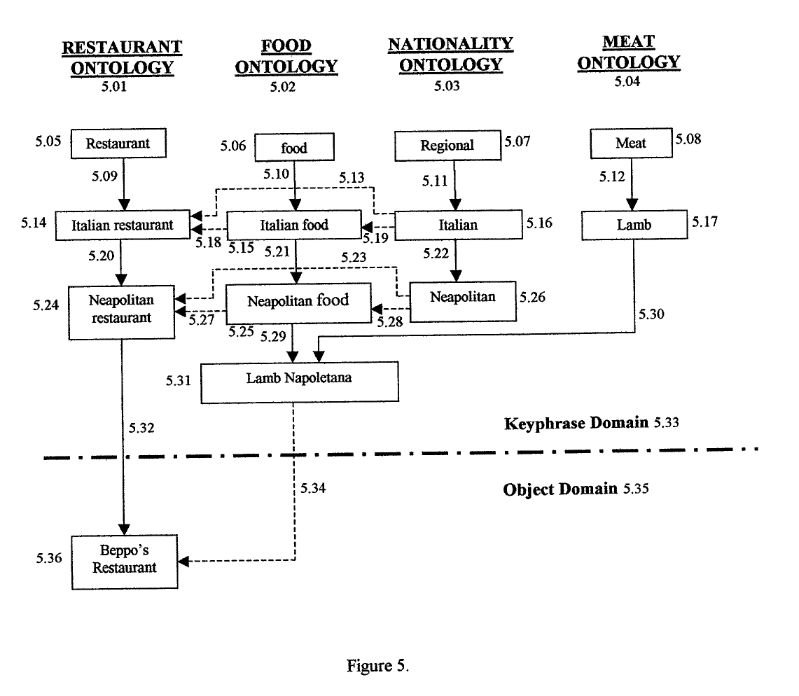

As the depth of ontologies in a cross-linked keyphrase ontology database grows, where depth is the number of levels of the average ontology in the database, the number of keyphrases attached to any retrievable object, and hence, the recall capabilities of the system, increase accordingly. This is illustrated by FIG. 5, which shows the results of adding one more layer of depth to the restaurant, food and nationality ontologies previously shown in FIG. 2. FIG. 5 shows a keyphrase domain 5.33 and an object domain 5.35 for a database used to index restaurants. The keyphrase domain 5.33 shown in FIG. 5 has four ontologies, one for restaurants (which are retrievable objects) 5.01, one for food types 5.02, one for nationalities 5.03, and one for meat 5.04. As shown in FIG. 5, the restaurant ontology 5.01 contains three keyphrase nodes representing the keyphrases “restaurant” 5.05, “Italian restaurant” 5.14, and “Neapolitan restaurant” 5.24, from which the object node 5.36 representing “Beppo's restaurant” descends. The food ontology 5.02 shown in FIG. 5 has four keyphrase nodes representing the keyphrases “food” (keyphrase node 5.06), “Italian food” (keyphrase node 5.15), “Neapolitan food” (keyphrase node 5.25), and “lamb Napoletana” (keyphrase node 5.31). The nationality ontology 5.03 shown in FIG. 5 contains three keyphrase nodes representing the keyphrases “regional” (keyphrase node 5.07), “Italian” (keyphrase node 5.16), and “Neapolitan” (keyphrase node 5.26). The meat ontology 5.04 contains three keyphrase nodes representing the keyphrases “meat” (keyphrase node 5.08), “lamb” (keyphrase node 5.17), and “lamb Napoletana” (keyphrase node 5.31). The object domain 5.35 as shown in FIG. 5 includes just one object node 5.36 representing a retrievable object, keyphrase “Beppo's Restaurant.” In FIG. 5, the keyphrase nodes representing the keyphrases “Italian restaurant” (keyphrase node 5.14), “Italian food” (keyphrase node 5.15), “Italian” (keyphrase node 5.16), “Lamb Napoletana” (keyphrase node 5.31) and the object node representing the keyphrase “Beppo's restaurant” (keyphrase node 5.36), are cross-linked with each other in the same way as shown in FIG. 2.

The difference between FIG. 5 and FIG. 2 is that: (i) the keyphrase “Neapolitan restaurant” (keyphrase node 5.24) has been added to the restaurant ontology 5.01; (ii) “Neapolitan food” node 5.25 has been added to the food ontology 5.02; and (iii) the keyphrase “Neapolitan” (keyphrase node 5.26) has been added to the nationality ontology 5.03. Following the rules described above, for determining which keyphrases are linked to an object represented by a node in the object domain, as the result of the changes reflected in FIG. 5, “Beppo's restaurant” (object node 5.36) is linked with the additional keyphrases “Neapolitan restaurant” (keyphrase node 5.24), “Neapolitan food” (keyphrase node 5.25), “Neapolitan” (keyphrase node 5.26), as well as others which users are less likely to enter (e.g., “Italian Neapolitan restaurant”). The numbers of keyphrase cross-links associated with any given retrievable object increases combinatorially with increased ontology depth, due to cross-link and inheritance patterns.

Keyphrase nodes corresponding to keyphrases in the keyphrase domain may also labeled with synonyms or metonyms to facilitate the search process. A keyphrase node in the keyphrase domain corresponding to “automobile,” for example, can also be labeled with the synonym “car.” Synonyms with which keyphrase nodes are labeled may also include non-standard English (e.g., “bbq” for “barbecue”), non-English equivalents (e.g., “Napoletana” for “Neapolitan”), or even variant spellings of the same word (e.g., “barbeque” for “barbecue”). A keyphrase node in the keyphrase domain corresponding to “dining” in a restaurant database may also be labeled with the metonym “table.” Although “dining” and “table” are not synonymous, users may speak or write the word “table” in sentences in which they mean “dining” (e.g., “a restaurant with outdoor tables” rather than “a restaurant with outdoor dining”). Unlike synonyms, metonyms are highly domain dependent. “Table,” for instance, is not a metonym for “dining” in a furniture domain, where “dining tables” are known and are distinctive from other tables. Keyphrases can be in any natural language, including English.

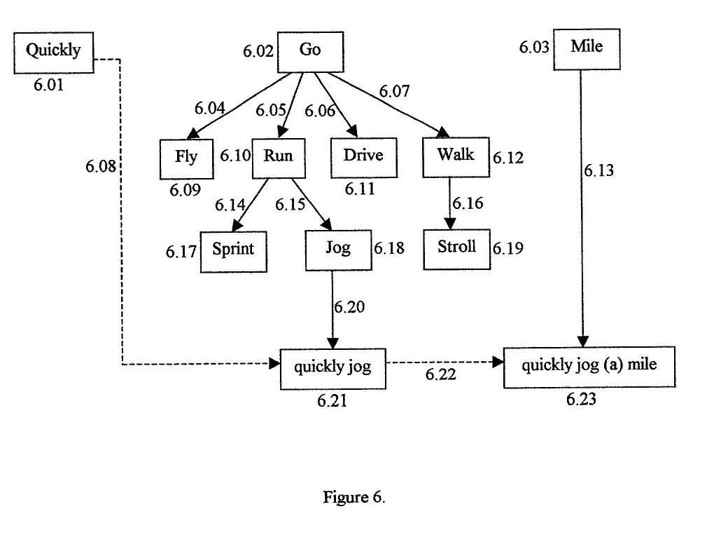

The ontologies shown in FIGS. 2 and 5 are noun and adjective ontologies. Verb ontologies can also be created and cross-linked and joined to adverb, noun and adjective ontologies. FIG. 6 shows an example ontology for verbs which correspond to various ways of “going.” As shown in FIG. 6, nodes 6.09-6.12 and 6.17-6.19 representing specific ways of “going” connected by inheritance links 6.04-6.07 and 6.14-6.16 to a node 6.02 representing “go” in general. A keyphrase node 6.01 representing the keyphrase “quickly” is cross-linked 6.08 with a child 6.21 of“jog” to represent the verbal keyphrase “quickly jog” (“quickly jog” is a child of “jog” by virtue of the inheritance link 6.20 which connects keyphrase nodes 6.18 and 6.21). The keyphrase node 6.01 corresponding to the keyphrase “quickly” is shown as a single keyphrase node. A child 6.23 of a keyphrase node 6.03 representing “mile,” also shown here as a single keyphrase node, is cross-linked 6.22 to the keyphrase node 6.21 representing the keyphrase “quickly jog,” to represent the three-word verbal keyphrase “quickly jog (a) mile” 6.23. FIG. 6 shows a schema for representing verbal keyphrases which assign head word status to the noun syntactic object (“mile” in this case). Conceptually, this is equivalent to the three-word keyphrase representing a “mile (that is) quickly jogged.”

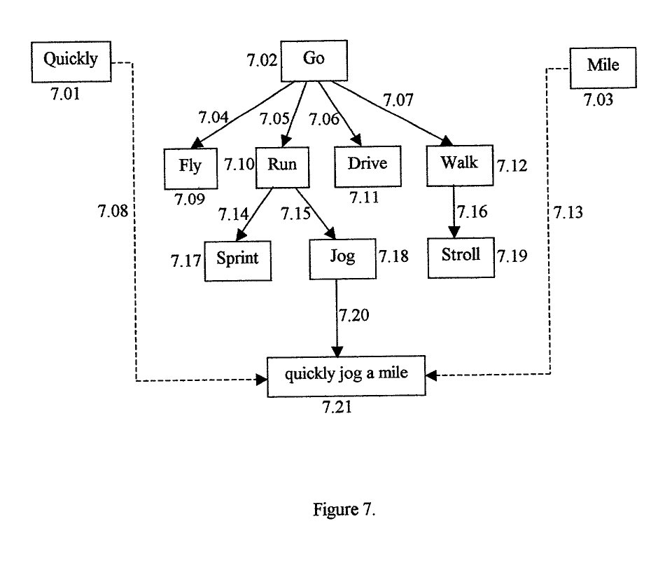

Verbs can also function as head words, in which cases adverbs and some or all of their syntactic arguments can be attached to them. FIG. 7 shows the same example ontology for verbs which correspond to various ways of “going” as shown in FIG. 6. Nodes 7.09-7.12 and 7.17-7.19 representing specific ways of “going” connected by inheritance links 7.04-7.07 and 7.14-7.16 to a node 7.02 representing “go” in general. FIG. 7 also shows a node 7.01 representing the keyphrase “quickly,” and a node 7.03 representing the keyphrase “mile.” FIG. 7 shows how the three-word keyphrase “quickly jog (a) mile” could be represented by a keyphrase node 7.21 descended from the keyphrase node 7.18 corresponding to “jog.” The choice of these or other schemes for cross-linking nouns and verbs depends on properties of the database domain and can be chosen for reasons of convenience, as long as one scheme is carried through consistently in deploying this invention.

In general, a cross-linked keyphrase ontology database is a database in which:

(a) keyphrases are represented as keyphrase nodes in ontologies, each ontology having as many keyphrase nodes (and as great a depth) as necessary to represent a domain;

(b) keyphrases may be generated by parsing a text;

(c) keyphrases are represented as intersections of ontologies, or by cross-linking a keyphrase node descendant from one or more ontology(ies) to keyphrase nodes belonging to other ontologies, or any equivalent representations;

(d) keyphrases may include one or more words in common;

(e) cross-links are inherited through ontologies;

(f) given the rules of inheritance, cross-links are created to relate all descendants of a recipient keyphrase node with appropriate keyphrases, given the data domain; and

(g) retrievable objects are represented by object nodes descendant from at least one keyphrase node in the keyphrase ontologies and possibly cross-linked directly (rather than by inheritance) with one or more keyphrase nodes in the keyphrase ontologies.

Indexing Retrievable Objects

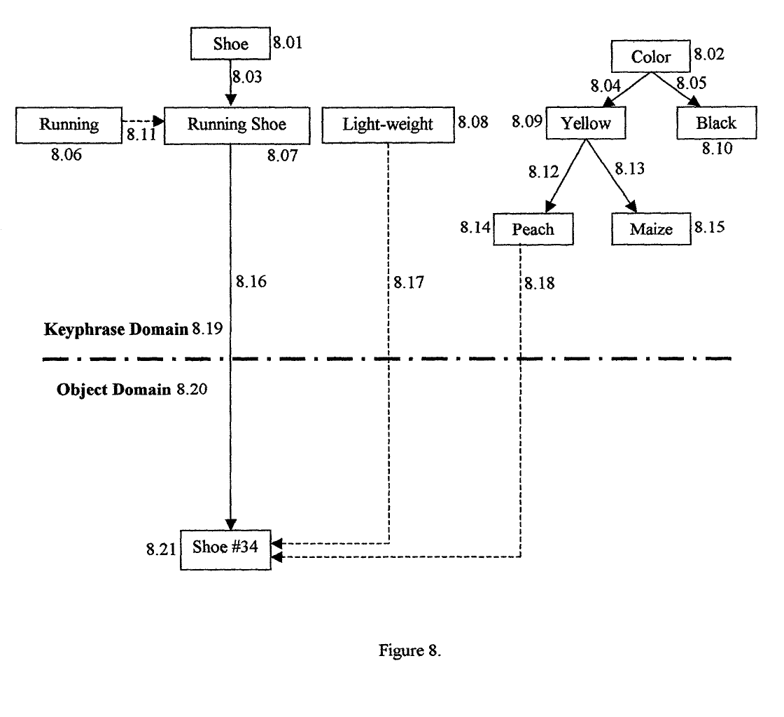

The process of indexing retrievable objects, including documents, web pages, pointers and executable computer programs, in the object domain is the process of linking the object nodes with keyphrase nodes in the keyphrase domain by inheritance links and cross-links. Generally, the method of indexing retrievable objects involves the following steps: (a) representing the retrievable object by an object node in an ontology; and (b) cross-linking the object node to a keyphrase node, where the keyphrase node represents a keyphrase in a second ontology and the keyphrase is related to the retrievable object. In one embodiment, the keyphrase is determined by parsing a text associated with the retrievable object. The retrievable object may be a document, a web page, a pointer or an executable computer program. This can be readily achieved by indexers with graphical and command line tools, or can be achieved automatically, using a natural language understanding device, or parser, or a relational database interface. For a particular object, indexers can simply anticipate, using their knowledge of the particular domain, keyphrases that others may use in searching for an item like the object being indexed. These keyphrases are therefore related to the objects being indexed. If the object, for example, is a peach running shoe, the indexer might anticipate that the keyphrases “peach” and “running shoe” might be produced by users seeking a similar item. By creating an inheritance link between the object node representing the object and a node representing “running shoe” in a shoe ontology, and a cross-link from the object node to a node representing “peach” in a color ontology, the indexer can insure that users whose input produces, when processed by a natural language understanding system the keyphrases “peach” and “running shoe” will be returned the object node currently being indexed. FIG. 8 shows how a cross-linked keyphrase ontology database might be constructed for such a shoe domain. As shown in FIG. 8, the keyphrase domain 8.19 contains a shoe ontology comprising two keyphrase nodes 8.01 and 8.07 and a color ontology comprising five keyphrase nodes 8.02, 8.09, 8.10, 8.14 and 8.15. In FIG. 8, additional keyphrase nodes are shown representing “running” (keyphrase node 8.06) and “light-weight” (keyphrase node 8.08), but are not shown in ontologies. An object node 8.21 in the object domain 8.20 represents a particular shoe, Shoe #34 (object node 8.21), which is a child of the keyphrase node 8.07 representing the keyphrase “running shoe.” Shoe #34 (object node 8.21) is cross-linked 8.17 and 8.18 to keyphrase nodes 8.08 and 8.14 representing the keyphrases “light-weight” and “peach,” respectively as well as to a keyphrase node 8.06 representing the keyphrase “running,” by inheritance from its parent keyphrase node 8.07. Other keynodes 8.15 and 8.10 represent other possible cross-links or inheritances that are found in the cross-linked keyphrase ontology database.

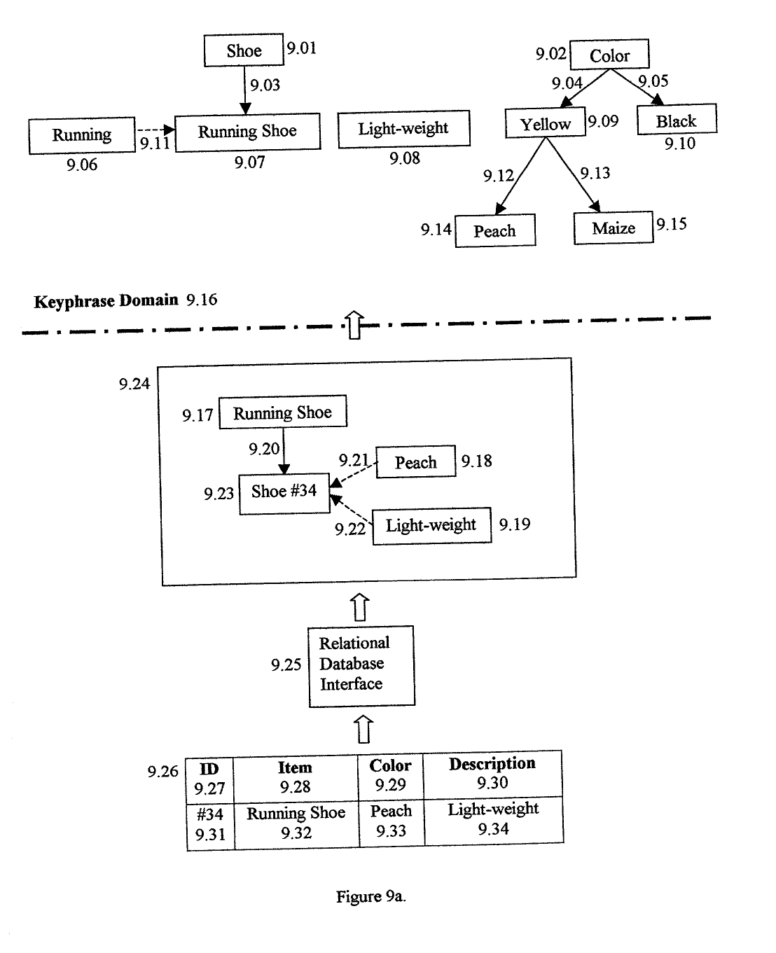

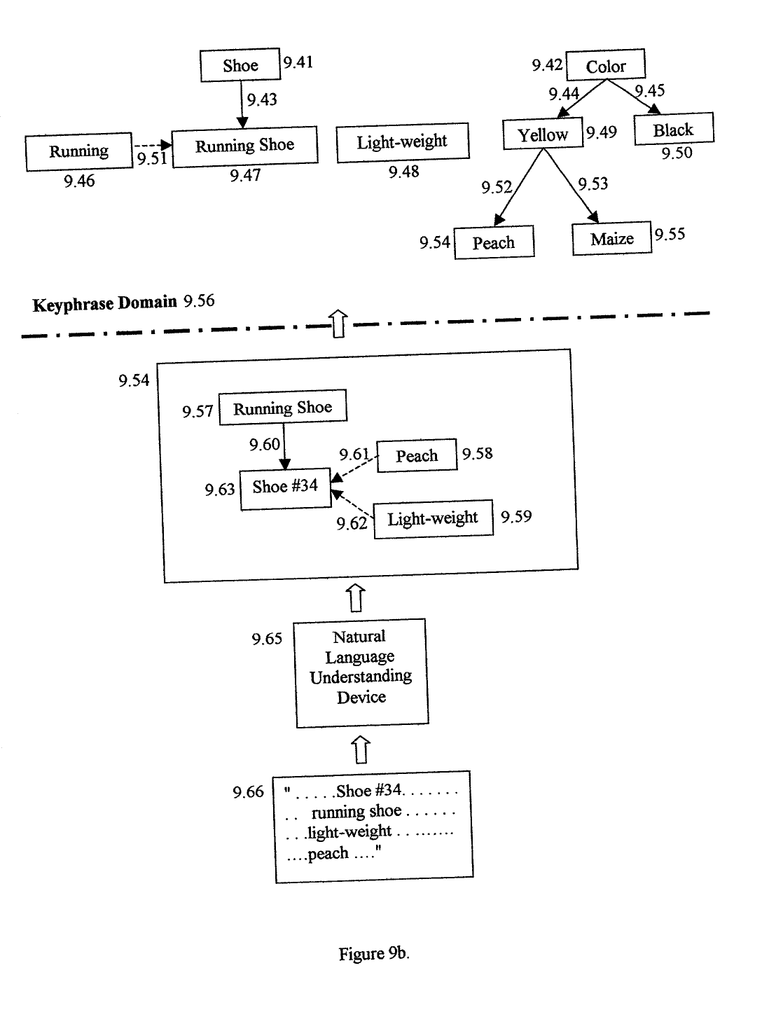

FIG. 9a shows the process of indexing Shoe #34 (object node 8.21) from data coming from a relational database or table of information. The upper part of FIG. 9a replicates the keyphrase domain of the cross-linked ontology database shown in FIG. 8 used to index shoes. The keyphrase domain 9.16 contains a shoe ontology comprising two keyphrase nodes 9.01 and 9.07 and a color ontology comprising five keyphrase nodes 9.02, 9.09, 9.10, 9.14 and 9.15. In FIG. 9, additional keyphrase nodes are shown representing “running” (keyphrase node 9.06) and “light-weight” (keyphrase node 9.08), but are not shown in ontologies.

As FIG. 9 shows, a table 9.26 containing information about Shoe #34 (object node 8.21, also shown here as 9.23) is processed by a relational database interface 9.25 to generate a structured representation 9.24 of Shoe #34 (object node 9.23). The table 9.26 shows attributes of Shoe #34 (object node 9.23) and therefore keyphrase nodes generated from table 9.26 are related to Shoe #34 (object node 9.23). The table 9.26 indicates that Shoe #34 (object node 9.23) is identified 9.27 by “#34” 9.31, the type of item 9.28 is a “running shoe” 9.32, its color 9.29 is “peach” 9.33, and a description 9.30 is that it is “lightweight” 9.34. The relational database interface 9.25 allows an indexer to specify whether values found in a column in a relational database should be linked to the object node being indexed by an inheritance link or a cross-link. The structured representation 9.24 shows that the object node 9.23 that represents the keyphrase Shoe #34 is connected by an inheritance link to the keyphrase node 9.17 that represents “running shoe” and is cross-linked 9.21 and 9.22 to keyphrase nodes 9.18, 9.19, respectively, that represent the keyphrases “peach” and “light-weight.” The structured representation 9.24 is then linked to the keyphrase domain of the cross-linked keyphrase ontology by linking the keyphrase nodes in the structured representation 9.24 to keyphrase nodes that represent the same keyphrases (or synonymous keyphrases) in the keyphrase domain 9.16. Thus the object node representing the keyphrase “Shoe #34” (object node 9.23) is connected by an inheritance link to “running shoe” (keyphrase node 9.07), and it is cross-linked to the keyphrase node 9.14 representing the keyphrase “peach” and the keyphrase node 9.08 representing the keyphrase “light-weight.”

FIG. 9b shows how the same information can be taken from a text that describes Shoe #34 (object node 8.21). Because the text is about Shoe#34 keyphrases derived from the text are related to Shoe#34. The upper part of FIG. 9a replicates the keyphrase domain of the cross-linked ontology database shown in FIG. 8 used to index shoes. The keyphrase domain 9.56 contains a shoe ontology comprising two keyphrase nodes 9.41 and 9.47 and a color ontology comprising five keyphrase nodes 9.42, 9.49, 9.50, 9.54 and 9.55. In FIG. 9b, additional keyphrase nodes 9.46, 9.48, respectively, are shown representing the keyphrases “running” and “light-weight”, but are not shown in ontologies.

Parts of the text 9.66 are processed with the natural language understanding device 9.65 to create a structured representation 9.54 of some of the information contained in the text 9.66. Parsing systems, or more generally, language understanding systems, that produce structured representations of natural language input using rules of syntax and grammar are well known (See Allen, J., Natural Language Understanding (Menlo Park, Calif.: Benjamin-Cummings, 1995), which is incorporated herein in its entirety by reference). In the example shown, the natural language understanding device 9.65 has generated the structured representation showing the object node Shoe #34 (object node 9.63) is a child of the node that represents “running shoe” (keyphrase node 9.57) and is cross-linked 9.61 and 9.62 to keyphrase nodes that represent “peach” (keyphrase node 9.58) and “light-weight” (keyphrase node 9.59). The structured representation 9.54 is then linked to the keyphrase domain of the cross-linked keyphrase ontology by linking the object node representing Shoe #34 (object node 9.63) to keyphrase nodes that represent the same keyphrases (or synonymous keyphrases) in the keyphrase domain 9.56. Thus the object node representing “Shoe #34” (object node 9.63) is connected by an inheritance link to “running shoe” (keyphrase node 9.47), and it is cross-linked to the keyphrase node representing “peach” (keyphrase node 9.54) and the node representing “light-weight” (keyphrase node 9.48).

Searching for Retrievable Objects

The methods and systems of the invention also permit searching a cross-linked keyphrase ontology database. Searching comprises the steps of:(a) parsing a natural language statement into a structured representation, where the structured representation comprises at least one keyphrase; (b) searching the cross-linked keyphrase ontology database for at least one object node, where the object node is cross-linked to a keyphrase node representing a second keyphrase, where the second keyphrase matches the keyphrase parsed in step (a); and (c) defining a search result as a retrievable object, wherein the retrievable object is represented by the object node. The search result can be displayed to a user in a list. The retrievable object may be an executable computer program. The natural language statement may be a query.

In one embodiment, the keyphrase in step (a) and the second keyphrase are identical. In another embodiment, the keyphrase in step (a) and the second keyphrase are synonyms and in another embodiment, the keyphrase in step (a) and the second keyphrase are metonyms.

Searching is done by converting an input query into a structured representation, and then finding object nodes in the cross-linked keyphrase ontology database that match the structured representation. The natural language understanding device constructs keyphrases from a natural language input query, and determines the structured representation of the query based on rules of syntax and grammar, and by disambiguation using the cross-linked keyphrase ontology database. The keyphrase “running shoes,” for example, may appear in an input sentence (e.g. “I want running shoes”), and may correspond to a keyphrase node, and hence a keyphrase, in a cross-linked keyphrase ontology database. However, the input may have taken the forms “I want shoes for running,” “I want shoes to use for running,” or others, in which the keyphrase “running shoes” does not appear. The natural language understanding device serves to retrieve the keyphrase “running shoes” from as many of these variant request constructions as possible.

This methods and systems of this invention are not, however, limited by a particular method of constructing structured representations. Other methods which may be used to form such representations are described in Allen, J., Natural Language Understanding (Menlo Park, Calif.: Benjamin-Cummings, 1995).

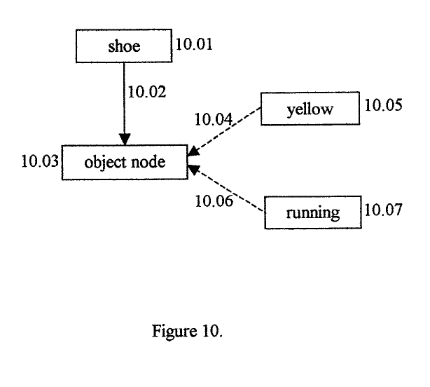

In the example shown, the cross-linked keyphrase ontology database illustrated in FIG. 8 has been set up and a user enters the query “I want a yellow running shoe.” FIG. 10 shows a structured representation of the object node 10.03 the query specifies based on the syntax of the query sentence. As shown in FIG. 10, the object node 10.03 specified in the query will be a descendant of a keyphrase node 10.01 representing the keyphrase “shoe” and will be cross-linked 10.04 and 10.06 to keyphrase nodes representing the keyphrases “yellow” (keyphrase node 10.05) and “running” (keyphrase node 10.07). In one embodiment of this invention, the structured representation shown in FIG. 10 also comprises keyphrases formed by ordered series of shorter keyphrases 10.01, 10.05 and 10.07, such as “yellow shoe” or “running shoe.”

The directory database of this invention, illustrated in FIG. 8, can be searched to find every retrievable object cross-linked with the keyphrases “shoe” (keyphrase node 8.01), “yellow” (keyphrase node 8.09), “running” (keyphrase node 8.06), or “running shoe” (keyphrase node 8.07), which are some of the keyphrases comprised by the structured representation shown in FIG. 10. In the case of FIG. 8, Shoe #34 (object node 8.21) is returned because:

1) The keyphrase Shoe#34 (object node 8.21) is a descendent of “running shoe” (keyphrase node 8.07), and therefore is cross-linked with the keyphrase “running shoe” (keyphrase node 8.07); and

2) The keyphrase Shoe#34 (object node 8.21) is cross-linked with the keyphrase “yellow” (keyphrase node 8.09), because the keyphrase “peach” (keyphrase node 8.14) is a descendant of the keyphrase “yellow” (keyphrase node 8.09) in the color ontology.

Alternatively, the keyphrase Shoe #34 (object node 8.21) could have been returned because:

1) The keyphrase Shoe #34 (object node 8.21) is a descendant of the keyphrase “shoe” (keyphrase node 8.01), and therefore is cross-linked with the keyphrase “shoe” (keyphrase node 8.01);

2) The keyphrase Shoe #34 (object node 8.21) is a descendant of the keyphrase “running shoe” (keyphrase node 8.07), and therefore inherits the keyphrase “running” (keyphrase node 8.06); and

3) The keyphrase Shoe#34 (object node 8.21) is cross-linked with the keyphrase “yellow” (keyphrase node 8.09), because “peach” (keyphrase node 8.14) is a descendant of the keyphrase “yellow” (keyphrase node 8.09) in the color ontology.

This illustrates the process of matching an object node 10.03 in a structured representation (FIG. 10) with an object node 8.21 in a cross-linked keyphrase ontology database (FIG. 8). The match occurs where the object node in the cross-linked keyphrase ontology database is linked with the same keyphrases as the object node in the structured representation according to the rules by which keyphrases are linked to object nodes. The match described here is one in which keyphrases from the structured representation of user input match identically to the keyphrases cross-linked to the object node 8.21 representing the keyphrase Shoe #34 (object node 8.21). In another embodiment, the keyphrases from the structured representation of user input could match by being synonyms or metonyms of the keyphrases cross-linked to the object node representing the keyphrase Shoe #34 (object node 8.21).

Because the keyphrase Shoe#34 (object node 8.21) is a match it is passed to the output user interface device as part of a result set that can be displayed as a list. The result set can be shown to the user using any computer or displayed over a network. The result set can be presented visually, in text or graphic formats, or can be read aloud to the user. The output device may also display information about the keyphrase Shoe #34 (object node 8.21), along with context-appropriate text, such as “How do you like this shoe?” or “This shoe is on sale.”

Disambiguating Natural Language

The methods and systems of the invention also permit disambiguating a syntactically ambiguous natural language statement. Disambiguation comprises the steps of: (a) parsing the syntactically ambiguous natural language statement into at least two structured representations, where the first structured representation comprises at least one first keyphrase and the second structured representation comprises at least one second keyphrase; (b) searching a cross-linked keyphrase ontology database for a keyphrase node representing a third keyphrase, where third keyphrase matches the first keyphrase or the second keyphrase; (c) if the first keyphrase matches the third keyphrase and the second keyphrase does not match the third keyphrase, designating the first structured representation as a first statement interpretation; (d) if the second keyphrase matches the third keyphrase and the first keyphrase does not match the third keyphrase, designating the second structured representation as a second statement interpretation; and (e) if the first keyphrase matches the third keyphrase and the second keyphrase matches the third keyphrase or the first keyphrase does not match the third keyphrase and the second keyphrase does not match the third keyphrase determining that the syntactically ambiguous natural language statement cannot be disambiguated.

The syntactically ambiguous natural language statement may be a query. In one embodiment, the third keyphrase is identical to the first keyphrase or the second keyphrase. In another embodiment, the third keyphrase is a synonym of the first keyphrase or the second keyphrase, while in another embodiment the third keyphrase is a metonym of the first keyphrase or the second keyphrase.

Disambiguation may be done on any syntactically ambiguous natural language statement in the English language or in any other spoken or written language.

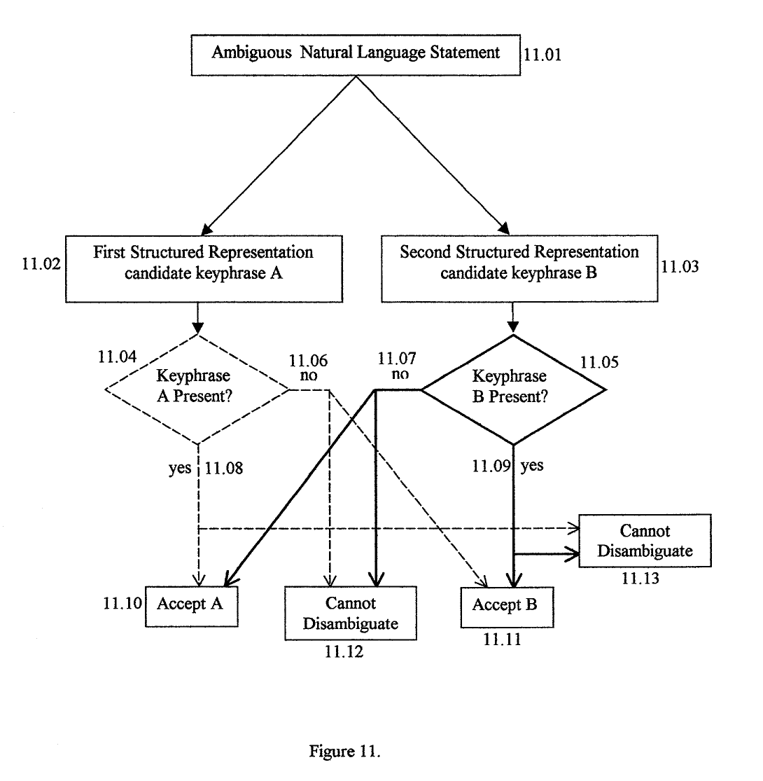

The method of disambiguation is further illustrated in FIG. 11 which is a flow chart for that method. FIG. 11 shows that an ambiguous natural language statement 11.01 is used to produce at least two alternative structured representations 11.02 and 11.03, each comprising at least one keyphrase, both of which are checked 11.04 and 11.05 against a database. If both keyphrases (A and B) are present in the database 11.08 and 11.09, or if neither keyphrase is present 11.06 and 11.07, the syntactic ambiguity in the original statement cannot be resolved with this method 11.12 and 11.13. If the first keyphrase (keyphrase A) 11.02 is present 11.08, but the second keyphrase (keyphrase B) 11.03 is not present 11.07 in the database, then the first keyphrase 11.02 is accepted 11.10 as the disambiguated interpretation of the statement 11.01. If the second keyphrase 11.03 is present 11.09, but the first keyphrase 11.02 is not present 11.06 in the database, then the second keyphrase 11.03 is accepted 11.11 as the disambiguated interpretation of the statement 11.01.

Syntactic rules are language-specific rules which specify word and phrase orders; one such rule in English, for example, is that head nouns in prepositional phrases, such as “cheese” in the phrase “with cheese,” must be attached to phrases that came before it in a sentence. Grammatical rules are language-specific rules governing use of punctuation; one such rule in English, for example, is that parallel words, such as “mushrooms,” “pepperoni,” and “cheese” in the phrase “with mushrooms, pepperoni, and cheese,” must be separated by commas and/or conjunctions. Syntactically and grammatically ambiguous word and phrase attachment and reference is common in natural language and poses a major obstacle to language understanding. Semantic knowledge is knowledge of word meanings and knowledge of the domains to which the words refer. Semantic knowledge of “pizza,” for example, might include knowledge that the potential ingredients of pizza include tomato sauce, cheese, sausage, pepperoni, and mushrooms, among others.

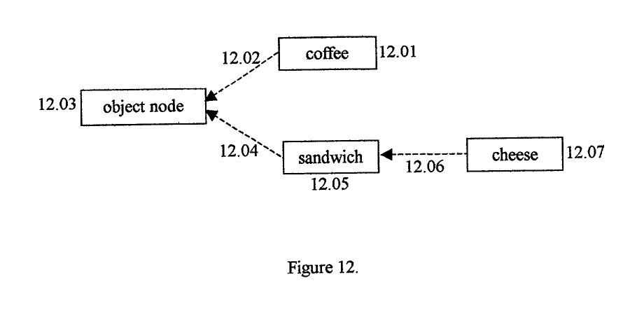

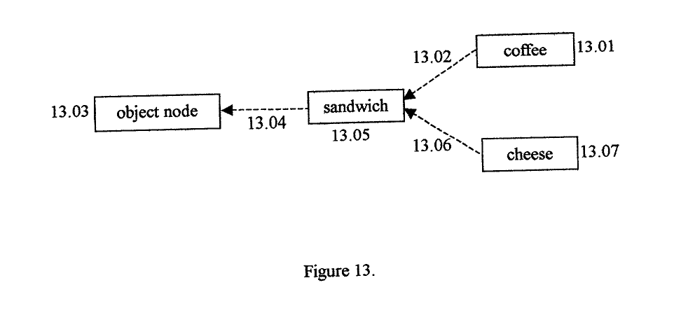

English speakers understand the possible input sentence, “I want a ham and cheese sandwich” as a request for one item. Such speakers understand the possible input sentence, “I want a coffee and cheese sandwich” as a request for two items. The distinction between these two sentences is based on semantic knowledge, not syntax: both “ham” and “coffee” are nouns, so the two sentences are syntactically identical. Speakers know that there is such a thing as a sandwich made with ham and cheese, and they know that there is not such a thing as a sandwich made in part of coffee, and these facts guide their interpretations of the two sentences. In a search for a restaurant, misinterpretation of such an input sentence would lead to erroneous keyphrases, and hence to a search failure. “Ham and cheese sandwich,” for example, could generate a search for a restaurant cross-linked with the keyphrases “ham” and “cheese sandwich,” if it were misunderstood, while “coffee and cheese sandwich” could generate a search for an object cross-linked with the keyphrase “coffee sandwich” or “coffee and cheese sandwich,” if it were misunderstood. The natural language understanding device can assign correct keyphrases to sentences like these and others which are syntactically ambiguous. The input phrase “coffee and cheese sandwich,” for example, would generate the two alternate representations shown in FIGS. 12 and 13, corresponding to different syntactic interpretations. FIG. 12 shows a structured representation comprising the keyphrases “coffee” and “cheese sandwich.” Since the representation of the keyphrase “coffee” (keyphrase node 12.01) is not directly linked to the representation of the keyphrase “sandwich” (keyphrase node 12.05), this representation does not comprise any keyphrase in which the keyphrase “sandwich” (keyphrase node 12.05) is syntactically modified by the keyphrase “coffee” (keyphrase node 12.01). The structured representation shown in FIG. 12 corresponds to the semantically correct interpretation of the phrase as signifying two different objects, coffee and a sandwich.

FIG. 13 shows a structured representation comprising the keyphrases “coffee sandwich” and “cheese sandwich.” Since the representation of the keyphrase “coffee” (keyphrase node 13.01) is directly linked 13.02 to the representation of the keyphrase “sandwich” (keyphrase node 13.05), this representation does comprise a keyphrase in which “sandwich” (keyphrase node 13.05) is syntactically modified by the keyphrase “coffee” (keyphrase node 13.01). The structured representation shown in FIG. 13 corresponds to the semantically incorrect interpretation of the phrase as signifying one object, “a sandwich made of coffee and of cheese.” Since the candidate keyphrase “coffee sandwich” will not be represented in the keyphrase domain of a cross-linked keyphrase ontology database, while the keyphrases “coffee” and “cheese sandwich” might be represented, the method of FIG. 11 will likely lead to the structured representation shown in FIG. 12 being accepted as the correctly disambiguated interpretation of the input phrase “coffee and cheese sandwich.”

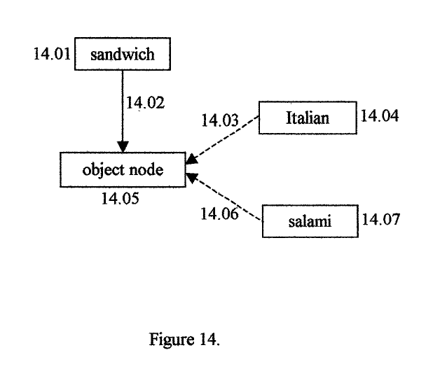

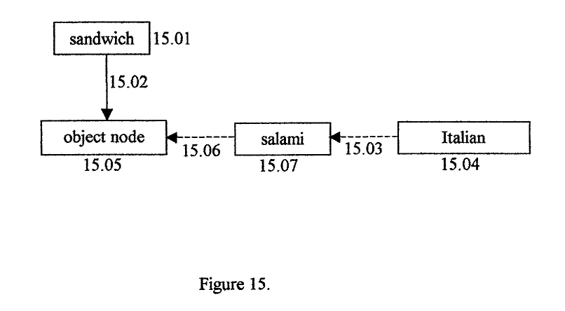

Similarly the natural language understanding system disambiguates attachment of contiguous modifiers by checking the keyphrase domain of the cross-linked keyphrase ontology database to see if candidate keyphrases exist in that domain. For example, the input phrase “Italian salami sandwich” might refer to an Italian sandwich composed of salami (with the resulting structured representation shown in FIG. 14) or a sandwich made with Italian salami (with the resulting structured representation shown in FIG. 15). In FIG. 14, an object node 14.05 which will match to an object node when the database is searched has an inheritance link 14.02 with a parent node 14.01 representing the keyphrase “sandwich” (keyphrase node 14.01) and receives cross-links 14.03 and 14.06 from nodes representing the keyphrase “Italian” (keyphrase node 14.04) and the keyphrase “salami” (keyphrase node 14.07). Because the representation of the keyphrase “Italian” (keyphrase node 14.04) in FIG. 14 is linked, via the object node 14.05, with the representation of the keyphrase “sandwich” (keyphrase node 14.01), FIG. 14 comprises keyphrases in which the keyphrase “sandwich” (keyphrase node 14.01) is syntactically modified by the keyphrase “Italian” (keyphrase node 14.04). In FIG. 15, an object node 15.05 which will match to an object node when the database is searched, has an inheritance link 15.02 with a parent node 15.01 representing the keyphrase “sandwich,” and a cross-link 15.06 to a keyphrase node 15.07 representing the keyphrase “salami,” which in turn has a cross-link 15.03 to a keyphrase node 15.04 representing the keyphrase “Italian.” Since the representation of the keyphrase “Italian” (keyphrase node 15.04) in FIG. 15 is not directly linked, via the object node 15.05, with the representation of the keyphrase “sandwich” (keyphrase node 15.01), FIG. 15 does not comprise keyphrases in which the keyphrase “sandwich” (keyphrase node 15.01) is syntactically modified by the keyphrase “Italian” (keyphrase node 15.04). Hence, the natural language understanding system could choose between these two structural representations by checking the keyphrase domain for the keyphrase “Italian sandwich.” Failing to find such a keyphrase, and instead finding a keyphrase node representing the keyphrase “Italian salami,” a keyphrase comprised by the structured representation shown in FIG. 15 but not by the structured representation shown in FIG. 14, might cause the natural language understanding system to accept a structured representation of the input phrase like that in FIG. 15 as the correctly disambiguated interpretation of the phrase “Italian salami sandwich.” Note, that if nodes representing neither or both of the keyphrases “Italian sandwich” and “Italian salami” can be found in the keyphrase domain (i.e., both or neither “sandwich with Italian salami” and an “Italian sandwich with salami” exist), then this method cannot be used to disambiguate the phrase “Italian salami sandwich.”

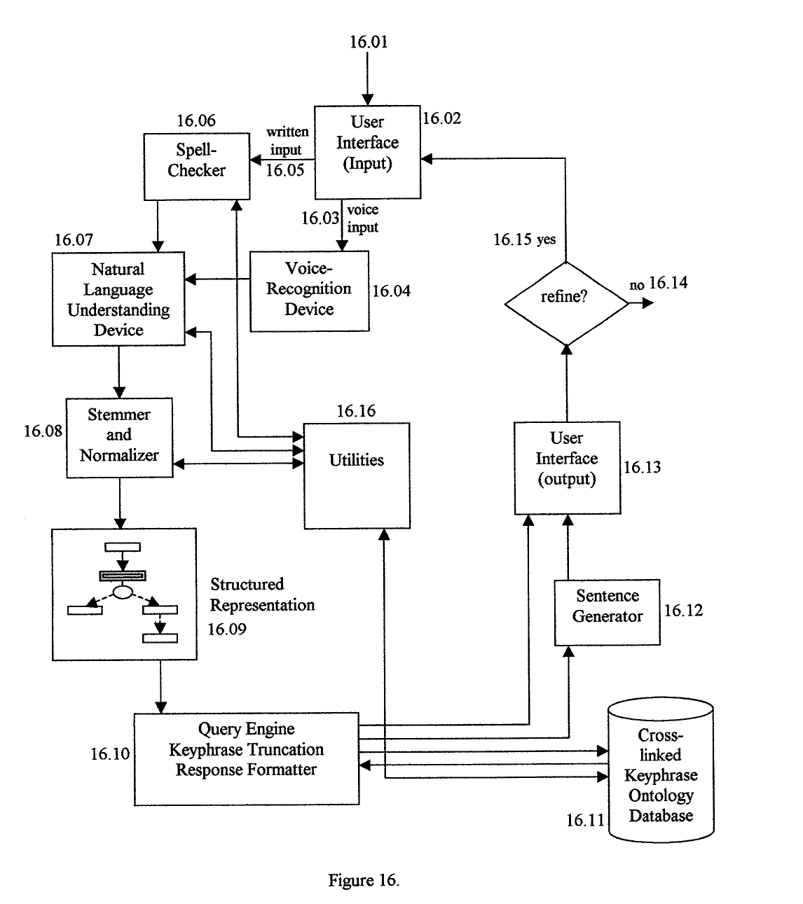

FIG. 16 is an illustration of one embodiment of this invention. This embodiment includes a user interface 16.02 through which users can input queries in written 16.05 or speech 16.03 form, a spell-checker 16.06, a speech-recognition device 16.04, a natural language understanding device 16.07, a word stemmer and normalizer 16.08, a query engine 16.10, a cross-linked keyphrase ontology database 16.11, a sentence generator 16.12, a user interface device providing responses to users 16.13 and a set of utilities 16.16. The utilities 16.16 interact with the spell-checker 16.06, the natural language understanding device 16.07, the stemmer and normalizer 16.08, and the cross-linked keyphrase ontology database 16.11. As shown FIG. 16, users can choose to refine 16.15 or not refine 16.14, queries they have previously input 16.01 based on the system's responses 16.13 to their initial query.

As shown in FIG. 16, user interaction 16.01 with this invention is initiated from an input device 16.02, which may be a text field, web page, or speech channel, or some other form. The cross-linked keyphrase ontology database allows highly reliable natural language keyphrase searches with minimal initial knowledge engineering. Hence, one embodiment of the invention, which takes advantage of its various properties, involves user input in the form of natural language text or speech. As shown in FIG. 16, if user input is written 16.05, a spell-checker 16.06 is used to normalize spelling. Jurafsky, et al., Speech and Language Processing (Upper Saddle River, N.J.: Prentice Hall, 2000) describes known methods of checking spelling, using computer devices. If user input is in the form of speech 16.03, a speech recognition device 16.04 must be used to convert input speech to a text string. Jurafsky, et al., Speech and Language Processing (Upper Saddle River, N.J.: Prentice Hall, 2000), describes known methods of converting speech to text, using computer devices.

As shown in FIG. 16, the text string from the spell-checker or from the speech recognition device is converted to a structured representation 16.09 by the natural language understanding device 16.07 and a stemmer and normalizer 16.08. Stemming refers to the process by which inflected verbs and comparative or superlative adjectives are transformed to their root forms and plural nouns are singularized. Normalizing is the process of changing various verb derivatives (such as “hiker”) to the verb roots, or lemmas, from which they were derived (such as “hike”). Normalization may be omitted or not, depending on the natural language understanding system used and the care with which the database is constructed. Stemming devices are known and many would serve the purpose of this embodiment.

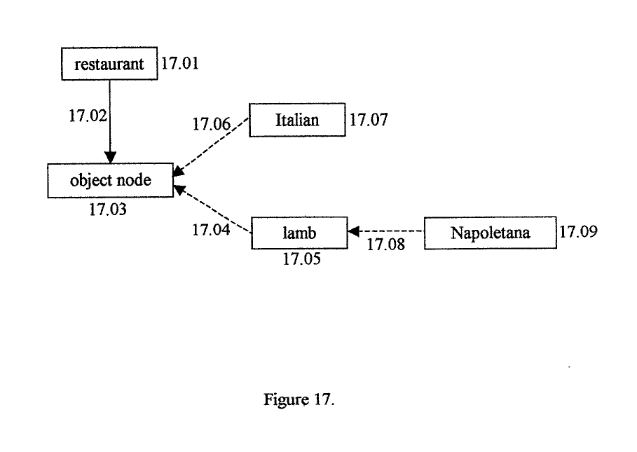

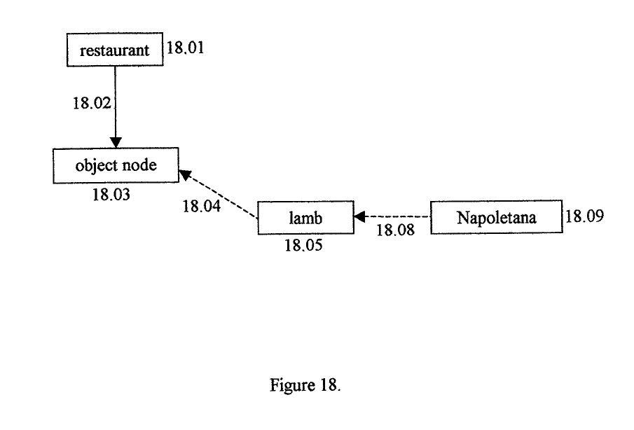

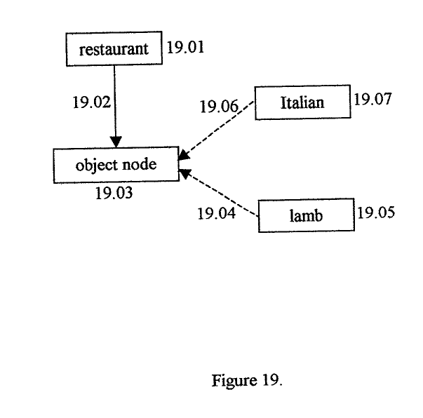

As shown in FIG. 16, the structured representation 16.09, now with stemmed and possibly normalized words, is then input to a query engine 16.10, which is a device which serves several purposes. First, the query engine takes the stemmed and normalized structured representation and uses it to search for objects in the cross-linked keyphrase ontology database 16.11. If objects with all the required cross-links are found in the database, the query engine 16.10 formats these items and passes information about them, and about the structured representation 16.09 which comprised its input, to the sentence generator 16.12 and output interface 16.13 devices. If no matching object nodes are found, the query engine 16.10 can truncate or eliminate keyphrases comprised by the structured representation 16.09 to find closest matches to input queries 16.01. For example, FIG. 17 shows a structured representation resulting from the sentence “I want an Italian restaurant with lamb Napoletana.” This structured representation indicates that the object node being sought 17.03 is linked with nodes representing the keyphrases “restaurant” (keyphrase node 17.01), “Italian” (keyphrase node 7.07), and “lamb Napoletana,” the last of which results from syntactic modification of “lamb” (keyphrase node 17.05) by “Napoletana” (keyphrase node 17.09). If no object node linked to nodes representing the keyphrases “restaurant,” (keyphrase node 17.01), “Italian” (keyphrase node 17.07) and “lamb Napoletana” is found in the cross-linked keyphrase ontology database, the structured representation shown in FIG. 17 can be altered in the query engine by truncating of keyphrases or parts of multi-word keyphrases. FIG. 18, for example, shows the structured representation resulting from truncating the representation 17.07 of keyphrase “Italian” (keyphrase node 17.09) from the structured representation shown in FIG. 17. The truncated structured representation shown in FIG. 18 indicates that the object node being sought 18.03 is linked with nodes representing the keyphrases, “restaurant” (keyphrase node 18.01) and “lamb Napoletana,” which results from syntactic modification of the keyphrase “lamb” (keyphrase node 18.05) by the keyphrase “Napoletana” (keyphrase node 18.09). Alternatively, truncating of the representation 17.09 of“Napoletana” from the truncated structured representation shown in FIG. 17 results in the structured representation shown in FIG. 19. The structured representation shown in FIG. 19 indicates that the object node being sought 19.03 is linked with nodes representing the keyphrases, “restaurant” (keyphrase node 18.01), “Italian” (keyphrase node 19.07) and “lamb” (keyphrase node 19.05). An object node with an inheritance link from a keyphrase node representing “restaurant” and cross-linked to a node representing the keyphrase “lamb Napoletana” will match the structured representation shown in FIG. 18, while an object node with an inheritance link from a keyphrase node representing “restaurant” and cross-linked to nodes representing the keyphrases “Italian” and “lamb” will match the structured representation shown in FIG. 19. Going even further, if object nodes like these cannot be found, truncating the representations of both keyphrases “Italian” (keyphrase node 17.07) and “Napoletana” (keyphrase node 17.09) from the structured representation shown in FIG. 17 will change the search to one for an object node with an inheritance link to a keyphrase node representing restaurant and with a single cross-link to a keyphrase node representing “lamb.”

Whatever search is finally performed, the results are formatted and passed to the sentence generator 16.12 and output user interface 16.13 device. If truncation has occurred in order to avoid an empty result set, the user can be informed, for example, that the closest match is a “restaurant with lamb Napoletana,” or “Italian restaurant with lamb,” or “a restaurant with lamb.” The user can then be given the chance to view such objects.

The sentence generator 16.12 shown in FIG. 16 is a device for creating natural language feedback which is displayed or read to the user through the output device 16.13. The purpose of such feedback, in an embodiment, is to keep the user informed of how the search performed, of the results, and of potential problems in query interpretation. To continue the example in the previous paragraph, for instance, the sentence generator may produce the following messages “Here are several Italian restaurants with lamb,” or “Your request couldn't be fully satisfied. The closest matches are Italian restaurants, or restaurants with lamb,” or other messages, depending on the search results. Sentence generation devices are known, and several of these can produce the sentences required for this embodiment, given properly formatted information from the query engine. Jurafsky, et al., Speech and Language Processing (Upper Saddle River, N.J.: Prentice Hall, 2000) describes some methods of sentence generation.

Feedback may be given to users via speech, rather than visually. In this case, information from the query engine 16.10 and sentence generator 16.12 are passed to a speech synthesis device, which converts text strings to spoken speech. Speech synthesis devices are known, and several could serve the purpose of this embodiment. Jurafsky, et al., Speech and Language Processing (Upper Saddle River, N.J.: Prentice Hall, 2000) describes some methods of speech synthesis. As shown in FIG. 16, this embodiment includes various utility devices 16.16 to create, load and maintain the database 16.11, and to log interactions and correct search errors.

Having described several different embodiments of the invention, it is not intended that the invention is limited to these embodiments and that modifications and variations may be made by one skilled in the art without departing from the spirit and scope of the invention as defined in the claims.

What is claimed is:

1. A method of generating a cross-linked keyphrase ontology database comprising the steps of:
(a) defining at least one keyphrase;
(b) representing the keyphrase by a keyphrase node in an ontology;
(c) cross-linking the keyphrase node to at least one second keyphrase node, wherein the second keyphrase node represents a second keyphrase in a second ontology; and
(d) repeating steps (b)-(c) for each keyphrase defined in step (a).

2. The method of claim 1, wherein the keyphrase in step (a) is generated by parsing a text.

3. The method of claim 1, wherein the keyphrase in step (a) is selected from a group consisting of nouns, adjectives, verbs and adverbs.

4. The method of claim 1, wherein the keyphrase in step (a) and the second keyphrase have at least one word in common.

5. The method of claim 2, wherein the text is in the English language.

6. A method of indexing a retrievable object in a cross-linked keyphrase ontology database comprising the steps of:
(a) representing the retrievable object by an object node in an ontology; and
(b) cross-linking the object node to a keyphrase node, wherein the keyphrase node represents a keyphrase in a second ontology and the keyphrase is related to the retrievable object.

7. The method of indexing of claim 6, wherein the keyphrase is determined by parsing a text related to the retrievable object.

8. The method of indexing of claim 6, wherein the retrievable object is a document.

9. The method of indexing of claim 6, wherein the retrievable object is a web page.

10. The method of indexing of claim 6, wherein the retrievable object is a pointer.

11. The method of indexing of claim 6, wherein the retrievable object is an executable computer program.

12. The method of searching a cross-linked keyphrase ontology database comprising the steps of:
(a) parsing a natural language statement into a structured representation, wherein the structured representation comprises at least one keyphrase;
(b) searching the cross-inked keyphrase ontology database for at least one object node, wherein the object node is cross-linked to a keyphrase node representing a second keyphrase, wherein the second keyphrase matches the keyphrase parsed in step (a); and
(c) defining a search result as a retrievable object, wherein the retrievable object is represented by the object node.

13. The method of searching of claim 12, wherein the search result is displayed to a user in a list.

14. The method of searching of claim 12, wherein the retrievable object is an executable computer program.

15. The method of searching of claim 12, wherein the natural language statement is a query.

16. The method of searching of claim 12, wherein the keyphrase in step (a) and the second keyphrase are identical.

17. The method of searching of claim 12, wherein the keyphrase in step (a) and the second keyphrase are synonyms.

18. The method of searching of claim 12, wherein the keyphrase in step (a) and the second keyphrase are metonyms.

19. The method of searching of claim 12, wherein the natural language statement is in the English language.

20. A method of disambiguating a syntactically ambiguous natural language statement comprising the steps of:
(a) parsing the syntactically ambiguous natural language statement into at least two structured representations, wherein the first structured representation comprises at least one first keyphrase and the second structured representation comprises at least one second keyphrase;
(b) searching a cross-linked keyphrase ontology database for a keyphrase node representing a third keyphrase, wherein the third keyphrase matches the first keyphrase or the second keyphrase;
(c) if the first keyphrase matches the third keyphrase and the second keyphrase does not match the third keyphrase, designating the first structured representation as a first disambiguated statement interpretation;
(d) if the second keyphrase matches the third keyphrase and the first keyphrase does not match the third keyphrase, designating the second structured representation as a second disambiguated statement interpretation; and
(e) if the first keyphrase matches the third keyphrase and the second keyphrase matches the third keyphrase or the first keyphrase does not match the third keyphrase and the second keyphrase does not match the third keyphrase, determining that the syntactically ambiguous natural language statement cannot be disambiguated.

21. The method of disambiguation of claim 20, wherein the syntactically ambiguous natural language statement is a query.

22. The method of disambiguating of claim 20, wherein the third keyphrase is identical to the first keyphrase or the second keyphrase.

23. The method of disambiguating of claim 20, wherein the third keyphrase is a synonym of the first keyphrase or the second keyphrase.

24. The method of disambiguating of claim 20, wherein the third keyphrase is a metonym of the first keyphrase or the second keyphrase.

25. The method of disambiguating of claim 20, wherein the syntactically ambiguous natural language statement is in the English language.
